(19) United States
(12) Patent Application Publication
(10) Pub. No.: US 2026/0021598 A1
(43) Pub. Date: Jan. 22, 2026

(54) KNIFE

(71) Applicant: MADI, LLC, Greenville, SC (US)

(72) Inventor: Andrew Morris, Bridgeport, TX (US)

(21) Appl. No.: 19/275,305

(22) Filed: Jul. 21, 2025

Related U.S. Application Data
(60) Provisional application No. 63/673,936, filed on Jul. 22, 2024.

(51) Int. Cl. B26B 1/02; G01C 15/10

(52) U.S. Cl. CPC B26B 1/02; G01C 15/10

(57) ABSTRACT

A knife is disclosed. The knife includes a housing having a first end and a second end; a blade connected to the first end of the housing; a pulley disposed in and rotatably connected to the second end of the housing; and a string connected to the pulley and configured to be stored on the pulley in a storage position and extend outwardly from the pulley in a use position.

### BACKGROUND OF THE INVENTION

This invention relates generally to tools, and more particularly to a knife for use by utility workers and the like.

While the knife is being described with respect to utility workers, the knife may be used by anyone needing a blade to cut. In the utility industry, it is important that utility poles are positioned vertically such that they are perpendicular to a level surface (i.e. plumb). There are various methods of doing this (for example, using a carpenter's level or other leveling device that indicates the vertical position of the utility pole), but the most common method is to visually use a plumb bob of some type. In this method, a plumb bob is held up with the pole in the background. The string of the plumb bob is then used to evaluate whether the centerline of the utility pole is completely vertical.

While a plumb bob or carpenter's level are simple to use, their use adds an additional tool that linemen must carry to perform the job at hand. Thus, it would be advantageous to minimize the number of tools carried by the linemen by utilizing a tool they already carry.

### BRIEF SUMMARY OF THE INVENTION

This problem is addressed by a knife having a plumb bob built into a handle of the knife.

Additionally as disclosed herein, a knife includes a housing having a first end and a second end; a blade connected to the first end of the housing; a pulley disposed in and rotatably connected to the second end of the housing; and a string connected to the pulley and configured to be stored on the pulley in a storage position and extend outwardly from the pulley in a use position.

As disclosed herein, a knife includes a housing having a first end and an opposing second end, the second end including a cavity formed therein; a blade connected to the first end of the housing; a pulley disposed in the cavity and rotatably connected to the second end; a string connected to the pulley and configured to wrap around the pulley in a stored position and extend outwardly from the pulley in a use position.

As disclosed herein, a method of verifying a structure is plumb includes providing a knife having: a housing; a blade connected to a first end of the housing; a pulley rotatably connected to a second end of the housing; and a string connected to the pulley; pulling the string outwardly from the pulley and allowing the knife to hang therefrom; securing a distal end of the string to a stationary structure and allowing the knife to stabilize; and verifying the structure is vertically aligned with the string.

### BRIEF DESCRIPTION OF THE DRAWINGS

The invention may be best understood by reference to the following description taken in conjunction with the accompanying drawing figures, in which:

FIG. 1 is a front side view of an exemplary knife according to an embodiment of the invention, in an open position;

FIG. 2 is a rear side view of the knife of FIG. 1, in an open position;

FIG. 3 is a front side view of the knife of FIG. 1, in a closed position;

FIG. 4 is a rear view of the knife of FIG. 1; and

FIG. 5 illustrates the knife of FIG. 1 used as a plumb bob.

### DETAILED DESCRIPTION OF THE INVENTION

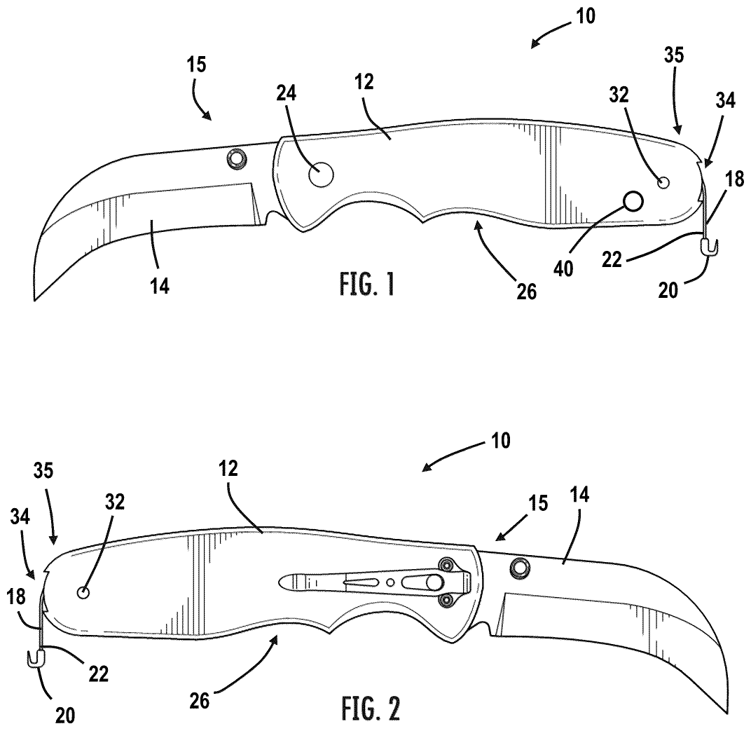

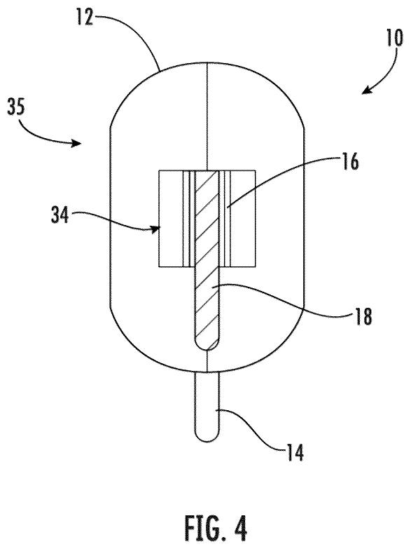

Referring to the drawings wherein identical reference numerals denote the same elements throughout the various views, FIGS. 1-4 illustrate an exemplary knife 10. knife 10 includes a handle and/or outer housing 12 having a left housing section 13 and a right housing section 17, a blade 14 pivotally connected to the housing 12 between the left and right housing sections 13 and 17 by pivot 24, a pulley 16 rotatably connected to the housing 12, a string 18 connected to the pulley 16, and a connector 20 (tab, hook, or other suitable connector) connected to a distal end 22 of the string 18.

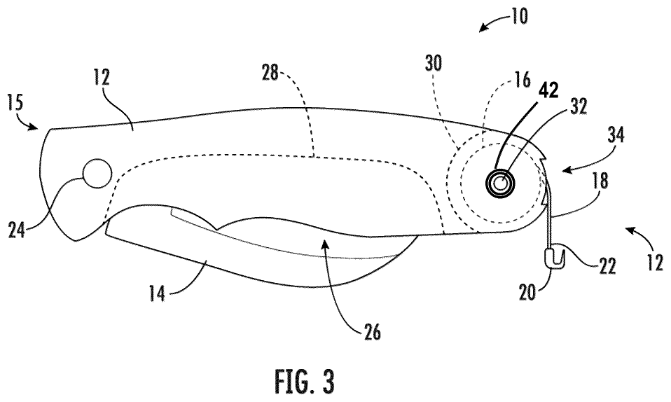

The blade 14 is adapted to move between an open position, FIG. 1, and closed position, FIG. 3. While the knife 10 is being described herein as having a pivotally connected blade 14 to move between the open and closed position, it should be appreciated that the blade 14 may be fixed in the open position and, as such, the invention applies to both fixed and pivotally connected solutions.

As shown, the blade 14 is pivotally connected to the housing 12 by pivot 24 at a front 15 of the housing 12 to allow the blade 14 to move between the closed position and the open position. The pivot 24 may be any suitable type of pivot, for example, a two-piece threaded connection or pin. The housing includes a slot 26 therein to receive at least a portion of the blade 14 into a first interior, opening, or cavity 28 of the housing 12. Additionally, the blade may include a lock-blade type mechanism, flip mechanism, or be a freely moving blade type.

As shown, the left housing section 13 and right housing section 17 are connected together to create the outer housing 12. The housing sections 13 and 17 may be connected together by fasteners extending therethrough, by female and male connectors that snap together, adhesives, or any other suitable method of connecting the housing sections 13 and 17 together to create the outer housing 12. As shown in FIG. 3, when connected, the left housing section 13 and right housing section 17 form slot 26 along a bottom 27 of the outer housing 12 for allowing the blade 14 to retract into the first interior 28 of the outer housing 12 when moved to the closed position.

The housing 12 may be of a multi-piece design such as the two-piece design shown and described above or a one-piece design and includes a second interior, opening, or cavity 30 for containing the pulley 16 and string 18 therein. It should be appreciated that the first and second interiors 28, 30 may be a single opening within an interior of the housing or separate openings. As shown, the pulley 16 is rotatably connected to a rear 35 of the housing 12 by a pivot 32. As discussed with respect to the blade 14, the pivot 32 may be a two-piece threaded connection, pin, or other suitable pivot. An aperture or slot 34 is formed in the rear 35 of the housing 12 to allow the string 18 to extend therethrough. Additionally, a lock 40 for engaging the pulley 16 may be used to prevent the pulley 16 from rotating, thereby preventing the string 18 from being pulled outwardly from the rear 35 of the knife 10.

It should be appreciated that while the pulley 16 is being described as being fully contained in the second interior 30 of the housing 12, the pulley 16 may be also be partially contained in the second interior 30 such that an upper and lower portion of the pulley 16 are exposed outside of the housing 12. In other words, a portion of the pulley 16 resides above a top edge of the housing 12 and a portion of the pulley 16 resides below a bottom edge of the housing 12.

The pulley 16 may be of any suitable material and has a diameter of about one-half inch to about one inch depending on the size of the knife. The pulley 16 is spring loaded (using spring 42) to allow the string 18 to be self-retracting (i.e. retracts into the handle 12 of the knife 10 without manually winding the string 18). The string 18 may be of any suitable material such as nylon and has a diameter of about 0.025 inches to about 0.045 inches and more particularly about 0.035 inches. The length of the string 18 is preferrable about four feet but any suitable length may be used. When the string 18 is retracted within the housing 12, the connector 20 is secured or stowed to prevent the connector 20 from catching on clothing or other structure or from interfering with the normal use of the knife 10.

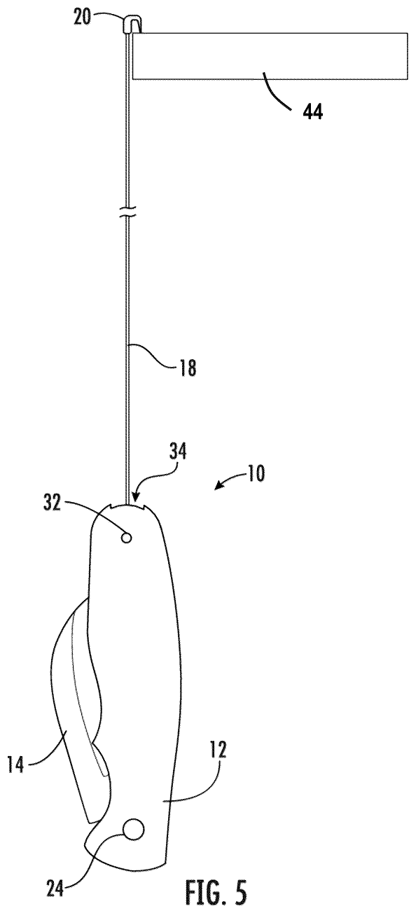

Referring to FIG. 5, in use, the user connects the connector 20 to a structure 44 (cross bar etc.) or holds the connector 20 against the structure to create a stable point of contact. The knife 10 is then allowed to drop as the weight of the knife 10 pulls the string 18 out of the housing 12 until the string 18 reaches an endpoint. The knife 10 is then allowed to stabilize such that the knife 10 no longer swings and/or moves, thereby causing the string 18 to form a vertical line that is easily viewed by the user. This vertical line created by the string is then compared with the utility pole to determine whether the utility pole is positioned vertically. In the case where the knife 10 includes lock 40, the user actuates the lock 40 to release engagement with the pulley 16 and allow the pulley 16 to rotate and the string 18 to be pulled outwardly away from the pulley 16.

The foregoing has described a knife. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. A knife, comprising:
a housing having a first end and a second end;
a blade connected to the first end of the housing;
a pulley disposed in and rotatably connected to the second end of the housing; and
a string connected to the pulley and configured to be stored on the pulley in a storage position and extend outwardly from the pulley in a use position.

2. The knife of claim 1, wherein the second end of the housing includes an opening configured to permit the string to pass therethrough.

3. The knife of claim 1, wherein the blade is pivotally connected to the first end of the housing.

4. The knife of claim 1, further including a connector connected to a distal end of the string.

5. The knife of claim 1, wherein the housing includes first and second housing sections connected together to form the housing.

6. The knife of claim 1, further including a lock configured to engage the pulley and prevent the pulley from rotating.

7. A knife, comprising:
a housing having a first end and an opposing second end, the second end including a cavity formed therein;
a blade connected to the first end of the housing;
a pulley disposed in the cavity and rotatably connected to the second end;
a string connected to the pulley and configured to wrap around the pulley in a stored position and extend outwardly from the pulley in a use position.

8. The knife of claim 7, wherein the second end includes an opening configured to permit the string to pass therethrough, the opening extending into the cavity.

9. The knife of claim 7, wherein the blade is pivotally connected to the first end of the housing.

10. The knife of claim 7, wherein the housing includes first and second housing sections connected together to form the housing.

11. The knife of claim 10, wherein the first and second housing sections define a second cavity for receiving the blade therein when the blade is in a stored position.

12. The knife of claim 7, further including a connector connected to a distal end of the string.

13. The knife of claim 7, further including a spring for biasing the pulley in the stored position.

14. The knife of claim 7, further including a lock, the lock engaging the pulley to prevent rotation of the pulley and maintain the string in the stored position.

15. A method of verifying a structure is plumb, comprising:
providing a knife having:
a housing;
a blade connected to a first end of the housing;
a pulley rotatably connected to a second end of the housing; and
a string connected to the pulley;
pulling the string outwardly from the pulley and allowing the knife to hang therefrom;
securing a distal end of the string to a stationary structure and allowing the knife to stabilize; and
verifying the structure is vertically aligned with the string.

16. The method of claim 15, wherein the knife further includes a lock configured to engage the pulley and prevent the pulley from rotating.

17. The method of claim 16, further including the step of actuating the lock to release the pulley and allow the pulley to rotate and the string to be pulled outwardly from the pulley.
